(19) United States
(12) Patent Application Publication
(10) Pub. No.: US 2026/0123661 A1
(43) Pub. Date: May 7, 2026

(54) A SHEET OF AEROSOL GENERATING MATERIAL FOR A COMPONENT OF AN ARTICLE AND APPRATUS AND METHOD FOR FORMING THE SHEET

(71) Applicant: NICOVENTURES TRADING LIMITED, London (GB)

(72) Inventors: Daniel BRAY, London (GB); Jeong Hwan Park, London (GB); Richard LEBBON, London (GB)

(21) Appl. No.: 19/120,385

(22) PCT Filed: Oct. 20, 2023
(86) PCT No.: PCT/GB2023/052739

§ 371 Date: Apr. 11, 2025

(30) Foreign Application Priority Data
Oct. 21, 2022 (GB) 2215639.2

(51) Int. Cl. A24B 3/14; A24B 15/167; A24C 5/01; A24C 5/18; A24C 5/28; A24D 1/20; B26D 3/00

(52) U.S. Cl. CPC A24B 3/14; A24B 15/167; A24C 5/01; A24C 5/1828; A24C 5/28; A24D 1/20; B26D 3/00

(57) ABSTRACT

A sheet of aerosol generating material includes a plurality of elongate partial cuts extending through at least 55% of a thickness of the sheet. At least some of the elongate partial cuts are configured to rupture to form a plurality of elongate strips of aerosol generating material having at least one burred edge. The invention also relates to a component of an article formed from a sheet of aerosol generating material, and an article including the component. The invention further relates to an apparatus for and a method of manufacturing a sheet of aerosol generating material and rods of aerosol generating material.

### RELATED APPLICATIONS

The present application is a National Phase entry of PCT Application No. PCT/GB2023/052739 filed Oct. 20, 2023, which claims priority to GB Application No. 2215639.2 filed Oct. 21, 2022, each of which is hereby incorporated by reference in their entirety.

### TECHNICAL FIELD

The present invention relates to a sheet of aerosol generating material. The present invention also relates to an apparatus for manufacturing the sheet of aerosol generating material and a method of manufacturing the sheet of aerosol generating material. The present invention further relates to a component comprising a rod formed from the sheet of aerosol generating material and an article comprising the component, as well as an apparatus for manufacturing the rod and a method of manufacturing the rod.

### BACKGROUND OF THE INVENTION

It is known to provide articles for use in an aerosol generating device which can be heated to generate and aerosol. The aerosol is drawn downstream by a user to be inhaled and usually passes through a mouthpiece.

### SUMMARY OF THE INVENTION

According to an embodiment of the present invention, there is provided a sheet of aerosol generating material comprising: a plurality of elongate partial cuts extending through at least 55% of a thickness of the sheet, wherein at least some of the elongate partial cuts are configured to rupture to form a plurality of elongate strips of aerosol generating material comprising at least one burred edge.

In some embodiments, the plurality of elongate partial cuts may extend in the longitudinal direction of the sheet of aerosol generating material.

In some embodiments, the plurality of elongate cuts may extend through at least 80% of the thickness of the sheet.

In some embodiments, the plurality of elongate partial cuts may extend through the thickness of the sheet to define a plurality of partially separated elongate strips and wherein adjacent partially separated strips are connected by a first connecting portion.

In some embodiments, each of the first connecting portions may have a thickness in the range of 5 um and 140 um.

In some embodiments, the plurality of elongate partial cuts may be spaced apart in the width direction of the sheet by a distance in the range of 0.8 mm to 1.2 mm.

In some embodiments, when one of the elongate partial cuts is ruptured, side surfaces of two adjacent elongate strips may comprise a first section and a second section, wherein the second section may form the burred edge and may have a rougher surface than the first section.

In some embodiments, the second surface may be created when adjacent partially separated elongate strips are torn apart and the partial cut propagates through the first connecting portion.

In some embodiments, the sheet of aerosol generating material may comprise in the range of 10 to 30 elongate partial cuts that, when all ruptured, form in the range of 12 to 32 separated elongate strips.

In some embodiments, each of the plurality of elongate partial cuts through the thickness of the sheet may extend partially along the longitudinal length of the sheet of aerosol generating material.

In some embodiments, the plurality of elongate partial cuts may have a length in the longitudinal direction of the sheet in the range of 2 mm to 15 mm.

In some embodiments, the plurality of elongate partial cuts may have a length in the longitudinal direction of the sheet in the range of 5 mm to 12 mm.

In some embodiments, the plurality of elongate partial cuts may be defined by second connecting portions.

In some embodiments, the second connecting portions may have a thickness equal to the thickness of the sheet of aerosol generating material.

In some embodiments, the second connecting portions may have a length in the longitudinal direction of the sheet in the range of 0.1 to 0.4 times the length of one of the plurality of elongate partial cuts.

In some embodiments, the second connecting portions may have a length in the longitudinal direction of the sheet in the range of 0.2 to 0.3 times the length of one of the plurality of elongate partial cuts.

In some embodiments, the second connecting portions may be aligned adjacent to each other across the width of the sheet material such that a band of aerosol generating material extends transversely across the sheet of aerosol generating material.

In some embodiments, at least one of the second connecting portions may be offset in the longitudinal direction of the sheet relative to at least one other of the second connecting portions.

In some embodiments, the component may comprise a plurality of second connecting portions in a longitudinal plane that extends orthogonally to a major surface of the sheet.

In another aspect of the present invention, there is provided a component for an aerosol generating device comprising: a rod of aerosol generating material comprising a plurality of elongate strips of aerosol generating material extending longitudinally through said rod; wherein the plurality of elongate strips of aerosol generating material are formed by partially cutting a sheet of aerosol generating material through at least 55% of a thickness of the sheet; and wherein at least one of the elongate partial cuts is configured to rupture to form a plurality of elongate strips of aerosol generating material comprising at least one burred edge.

In some embodiments, the elongate partial cuts may be configured to rupture to form a plurality of elongate strips of aerosol generating material comprising burred edges.

In some embodiments, the plurality of elongate strips may be formed by partially cutting a sheet of aerosol generating material through at least 80% of the thickness of the sheet.

In some embodiments, the plurality of elongate strips may have a width in the range of 0.8 mm to 1.2 mm.

In some embodiments, when ruptured, a side surface of each of the plurality of elongate strips may comprise a first section and a second section, wherein the second section may have a rougher surface than the first section.

In some embodiments, the second section may have a length in a direction perpendicular to the longitudinal axis of the component in the range of 5 um to 140 um.

In some embodiments, the second surface may be created when adjacent partially separated elongate strips are torn apart and the partial cut propagates through the first connecting portion.

In some embodiments, the plurality of elongate strips of aerosol generating material may be formed by partially cutting the sheet of aerosol generating material in the longitudinal direction, such that adjacent elongate strips are connected by at least one second connection portion of aerosol generating material.

In some embodiments, the second connection portions of aerosol generating material extend over 10% to 40% of the length of the rod of aerosol generating material.

In some embodiments, the second connecting portions may be located at the same distance in the longitudinal direction from an end of the rod of aerosol generating material.

In some embodiments, at least one of the second connecting portions may be offset in the longitudinal direction of the rod of aerosol generating material to at least one other of the second connecting portions.

According to another aspect of the present invention, there is provided an article comprising the component for an aerosol generating device according to any one of claim 20 to claim 30.

In another aspect of the present invention, there is provided an apparatus for manufacturing a sheet of aerosol generating material, the apparatus comprising: a first cutter configured to partially cut a sheet of aerosol generating material longitudinally to produce a plurality of elongate partial cuts; wherein the first cutter is configured to partially cut through at least 55% of a thickness of the sheet of aerosol generating material.

In some embodiments, rein the first cutter may be configured to partially cut through at least 80% of a thickness of the sheet of aerosol generating material.

In some embodiments, the first cutter may comprise a first portion and a second portion, wherein the first portion and the second portion may be arranged such that there is a gap between their outermost surfaces of between the range of 5 um and 140 um.

In some embodiments, the first portion may be a cutting drum comprising a first drum and a plurality of cutting elements, each cutting element having a cutting edge at its radial extremity that extends circumferentially around the first drum.

In some embodiments, one of the plurality of cutting elements may be separated from an adjacent cutting element by a distance in the range of between 0.5 mm and 2 mm.

In some embodiments, each of the plurality of cutting elements may be separated from an adjacent cutting element by a distance of about 1 mm.

In some embodiments, at least one of the cutting elements may comprise at least one notch extending in the circumferential direction, the at least one notch being configured to provide a generally circumferentially extending local area of the at least one cutting element that has a smaller radius than the cutting edge.

In some embodiments, the local area of the notch may be configured to discontinue a cut being made into a sheet of aerosol generating material.

In some embodiments, the local area of the notch is configured to remain out of contact with a sheet of aerosol generating material being cut.

In some embodiments, the notches on adjacent cutting elements may be aligned.

In some embodiments, the notches on adjacent cutting elements may be offset.

In some embodiments, the second portion may be an anvil drum.

In some embodiments, the first cutter may be a crush cutting apparatus.

In another aspect of the present invention, there is provided a method of forming a sheet of aerosol generating material, the method comprising: cutting a sheet of aerosol generating material longitudinally to produce a plurality of elongate partial cuts in the sheet; wherein cutting the sheet of aerosol generating material comprises partially cutting through at least 55% of a thickness of the sheet of aerosol generating material.

In some embodiments, cutting the sheet of aerosol generating material may comprise partially cutting through at least 80% of the thickness of the sheet of aerosol generating material.

In some embodiments, cutting the sheet of aerosol generating material may comprise partially cutting through the thickness of the sheet of aerosol generating material to define a plurality of partially separated elongate strips connected by a first connecting portion having a thickness in the range of 5 um to 140 um.

In some embodiments, cutting the sheet of aerosol generating material may comprise partially cutting the sheet of aerosol generating material in the longitudinal direction to form a plurality of elongate partial cuts.

In some embodiments, partially cutting the sheet of aerosol generating material in the longitudinal direction may comprise partially cutting along the length of the sheet of aerosol generating material to define a plurality of second connecting portions having a length in the longitudinal direction of the sheet in the range of 0.1 to 0.4 times the length of one of the plurality of elongate partial cuts.

In some embodiments, adjacent second connecting portions in the widthwise direction may be aligned.

In some embodiments, adjacent second connecting portions in the widthwise direction of the sheet may be offset in the longitudinal direction.

In another aspect of the present invention, there is provided an apparatus for manufacturing rods of aerosol generating material for an aerosol generating device component, the apparatus comprising: an apparatus according to any one of claim 32 to claim 43; a gatherer configured to gather the sheet of aerosol generating material together to form a rod, wherein the elongate partial cuts rupture to form a plurality of elongate strips of aerosol generating material and the plurality of elongate strips extend substantially longitudinally through the rod; and a second cutter configured to cut the rod into segments to produce rods of aerosol generating material.

In another aspect of the present invention, there is provided a method of forming a rod of aerosol generating material for an aerosol generating device component, the method comprising: forming a sheet of aerosol generating material according to any one of claim 44 to claim 50; gathering the sheet of aerosol generating material to form a rod of aerosol generating material, wherein the elongate partial cuts rupture to form a plurality of elongate strips of aerosol generating material and the plurality of elongate strips extend substantially longitudinally through the rod; and cutting the rod of aerosol generating material into segments to produce rods of aerosol generating material for an aerosol generating device component.

### BRIEF DESCRIPTION OF THE DRAWINGS

So that the invention may be more fully understood, embodiments of the present invention will now be described, by way of example only, with reference to the accompanying drawings, in which:

FIG. 1 shows a schematic top view of a sheet of aerosol generating material;

FIG. 2 shows a schematic cross-sectional view of the sheet of aerosol generating material shown in FIG. 1;

FIG. 3 shows a schematic top view of a sheet of aerosol generating material;

FIG. 4 shows a schematic cross-sectional view of the sheet of aerosol generating material shown in FIG. 3;

FIG. 5 shows a schematic top view of a sheet of aerosol generating material;

FIG. 6 shows a schematic cross-sectional view of the sheet of aerosol generating material shown in FIG. 5;

FIG. 7 shows a schematic perspective view of a component comprising a sheet of aerosol generating material;

FIG. 8 shows a schematic end view of an elongate strip ruptured from a sheet of aerosol generating material;

FIG. 9 shows a schematic side view of an elongate strip ruptured from a sheet of aerosol generating material;

FIG. 10 shows a schematic perspective view of an article comprising a component comprising a sheet of aerosol generating material;

FIG. 11 shows a schematic front view of a first cutter;

FIG. 12 shows a schematic side view of a cutting knife;

FIG. 13 shows a schematic side view of a cutting knife;

FIG. 14 shows a schematic front view of a first drum of a first cutter;

FIG. 15 shows a schematic front view of a first drum of a first cutter; and

FIG. 16 shows a schematic side view of an apparatus for manufacturing a rod of aerosol generating material.

### DETAILED DESCRIPTION

As used herein, the term “delivery system” is intended to encompass systems that deliver at least one substance to a user, and includes:
combustible aerosol provision systems, such as cigarettes, cigarillos, cigars, and tobacco for pipes or for roll-your-own or for make-your-own cigarettes (whether based on tobacco, tobacco derivatives, expanded tobacco, reconstituted tobacco, tobacco substitutes or other smokable material);
non-combustible aerosol provision systems that release compounds from an aerosol-generating material without combusting the aerosol-generating material, such as electronic cigarettes, tobacco heating products, and hybrid systems to generate aerosol using a combination of aerosol-generating materials.

According to the present disclosure, a “combustible” aerosol provision system is one where a constituent aerosol-generating material of the aerosol provision system (or component thereof) is combusted or burned during use in order to facilitate delivery of at least one substance to a user.

In some embodiments, the delivery system is a combustible aerosol provision system, such as a system selected from the group consisting of a cigarette, a cigarillo and a cigar.

In some embodiments, the disclosure relates to a component for use in a combustible aerosol provision system, such as a filter, a filter rod, a filter segment, a tobacco rod, a spill, an aerosol-modifying agent release component such as a capsule, a thread, or a bead, or a paper such as a plug wrap, a tipping paper or a cigarette paper.

According to the present disclosure, a “non-combustible” aerosol provision system is one where a constituent aerosol-generating material of the aerosol provision system (or component thereof) is not combusted or burned in order to facilitate delivery of at least one substance to a user.

In some embodiments, the non-combustible aerosol provision system is an electronic cigarette, also known as a vaping device or electronic nicotine delivery system (END), although it is noted that the presence of nicotine in the aerosol-generating material is not a requirement.

In some embodiments, the non-combustible aerosol provision system is an aerosol-generating material heating system, also known as a heat-not-burn system. An example of such a system is a tobacco heating system.

In some embodiments, the non-combustible aerosol provision system is a hybrid system to generate aerosol using a combination of aerosol-generating materials, one or a plurality of which may be heated. Each of the aerosol-generating materials may be, for example, in the form of a solid, liquid or gel and may or may not contain nicotine. In some embodiments, the hybrid system comprises a liquid or gel aerosol-generating material and a solid aerosol-generating material. The solid aerosol-generating material may comprise, for example, tobacco or a non-tobacco product.

Typically, the non-combustible aerosol provision system may comprise a non-combustible aerosol provision device and a consumable for use with the non-combustible aerosol provision device.

In some embodiments, the disclosure relates to consumables comprising aerosol-generating material and configured to be used with non-combustible aerosol provision devices. These consumables are sometimes referred to as articles throughout the disclosure.

In some embodiments, the non-combustible aerosol provision system, such as a non-combustible aerosol provision device thereof, may comprise a power source and a controller. The power source may, for example, be an electric power source or an exothermic power source. In some embodiments, the exothermic power source comprises a carbon substrate which may be energized so as to distribute power in the form of heat to an aerosol-generating material or to a heat transfer material in proximity to the exothermic power source.

In some embodiments, the non-combustible aerosol provision system may comprise an area for receiving the consumable, an aerosol generator, an aerosol generation area, a housing, a mouthpiece, a filter and/or an aerosol-modifying agent.

In some embodiments, the consumable for use with the non-combustible aerosol provision device may comprise aerosol-generating material, an aerosol-generating material storage area, an aerosol-generating material transfer component, an aerosol generator, an aerosol generation area, a housing, a wrapper, a filter, a mouthpiece, and/or an aerosol-modifying agent.

A consumable is an article comprising or consisting of aerosol-generating material, part or all of which is intended to be consumed during use by a user. A consumable may comprise one or more other components, such as an aerosol-generating material storage area, an aerosol-generating material transfer component, an aerosol generation area, a housing, a wrapper, a mouthpiece, a filter and/or an aerosol-modifying agent. A consumable may also comprise an aerosol generator, such as a heater, that emits heat to cause the aerosol-generating material to generate aerosol in use. The heater may, for example, comprise combustible material, a material heatable by electrical conduction, or a susceptor.

Aerosol-generating material is a material that is capable of generating aerosol, for example when heated, irradiated or energized in any other way. Aerosol-generating material may, for example, be in the form of a solid, liquid or gel which may or may not contain an active substance and/or flavorants. In some embodiments, the aerosol-generating material may comprise an “amorphous solid”, which may alternatively be referred to as a “monolithic solid” (i.e. non-fibrous). In some embodiments, the amorphous solid may be a dried gel. The amorphous solid is a solid material that may retain some fluid, such as liquid, within it. In some embodiments, the aerosol-generating material may for example comprise from about 50wt %, 60wt % or 70wt % of amorphous solid, to about 90wt %, 95wt % or 100wt % of amorphous solid.

The aerosol-generating material may comprise one or more active substances and/or flavors, one or more aerosol-former materials, and optionally one or more other functional material.

In some embodiments, the substance to be delivered may be an aerosol-generating material or a material that is not intended to be aerosolized. As appropriate, either material may comprise one or more active constituents, one or more flavors, one or more aerosol-former materials, and/or one or more other functional materials.

An aerosol-modifying agent is a substance, typically located downstream of the aerosol generation area, that is configured to modify the aerosol generated, for example by changing the taste, flavor, acidity or another characteristic of the aerosol. The aerosol-modifying agent may be provided in an aerosol-modifying agent release component, that is operable to selectively release the aerosol-modifying agent

The aerosol-modifying agent may, for example, be an additive or a sorbent. The aerosol-modifying agent may, for example, comprise one or more of a flavorant, a colorant, water, and a carbon adsorbent. The aerosol-modifying agent may, for example, be a solid, a liquid, or a gel. The aerosol-modifying agent may be in powder, thread or granule form. The aerosol-modifying agent may be free from filtration material.

In some embodiments, the substance to be delivered comprises an active substance.

The active substance as used herein may be a physiologically active material, which is a material intended to achieve or enhance a physiological response. The active substance may for example be selected from nutraceuticals, nootropics, psychoactives. The active substance may be naturally occurring or synthetically obtained. The active substance may comprise for example nicotine, caffeine, taurine, theine, vitamins such as B6 or B12 or C, melatonin, cannabinoids, or constituents, derivatives, or combinations thereof. The active substance may comprise one or more constituents, derivatives or extracts of tobacco, cannabis or another botanical.

In some embodiments, the active substance comprises nicotine. In some embodiments, the active substance comprises caffeine, melatonin or vitamin B12.

As noted herein, the active substance may comprise one or more constituents, derivatives or extracts of cannabis, such as one or more cannabinoids or terpenes.

As noted herein, the active substance may comprise or be derived from one or more botanicals or constituents, derivatives or extracts thereof. As used herein, the term “botanical” includes any material derived from plants including, but not limited to, extracts, leaves, bark, fibers, stems, roots, seeds, flowers, fruits, pollen, husk, shells or the like. Alternatively, the material may comprise an active compound naturally existing in a botanical, obtained synthetically. The material may be in the form of liquid, gas, solid, powder, dust, crushed particles, granules, pellets, shreds, strips, sheets, or the like. Example botanicals are tobacco, eucalyptus, star anise, hemp, cocoa, cannabis, fennel, lemongrass, peppermint, spearmint, rooibos, chamomile, flax, ginger, ginkgo biloba, hazel, hibiscus, laurel, licorice (liquorice), matcha, mate, orange skin, papaya, rose, sage, tea such as green tea or black tea, thyme, clove, cinnamon, coffee, aniseed (anise), basil, bay leaves, cardamom, coriander, cumin, nutmeg, oregano, paprika, rosemary, saffron, lavender, lemon peel, mint, juniper, elderflower, vanilla, wintergreen, beefsteak plant, curcuma, turmeric, sandalwood, cilantro, bergamot, orange blossom, myrtle, cassis, valerian, pimento, mace, damien, marjoram, olive, lemon balm, lemon basil, chive, carvi, verbena, tarragon, geranium, mulberry, ginseng, theanine, theacrine, maca, ashwagandha, damiana, guarana, chlorophyll, baobab or any combination thereof. The mint may be chosen from the following mint varieties: Mentha Arventis, Mentha c.v., Mentha niliaca, Mentha piperita, Mentha piperita citrata c.v., Mentha piperita c. v, Mentha spicata crispa, Mentha cardifolia, Memtha longifolia, Mentha suaveolens variegata, Mentha pulegium, Mentha spicata c.v. and Mentha suaveolens

In some embodiments, the active substance comprises or is derived from one or more botanicals or constituents, derivatives or extracts thereof and the botanical is tobacco.

In some embodiments, the active substance comprises or derived from one or more botanicals or constituents, derivatives or extracts thereof and the botanical is selected from eucalyptus, star anise, cocoa and hemp.

In some embodiments, the active substance comprises or derived from one or more botanicals or constituents, derivatives or extracts thereof and the botanical is selected from rooibos and fennel.

In some embodiments, the substance to be delivered comprises a flavor.

As used herein, the terms “flavor” and “flavorant” refer to materials which, where local regulations permit, may be used to create a desired taste, aroma or other somatosensorial sensation in a product for adult consumers. They may include naturally occurring flavor materials, botanicals, extracts of botanicals, synthetically obtained materials, or combinations thereof (e.g., tobacco, cannabis, licorice (liquorice), hydrangea, eugenol, Japanese white bark magnolia leaf, chamomile, fenugreek, clove, maple, matcha, menthol, Japanese mint, aniseed (anise), cinnamon, turmeric, Indian spices, Asian spices, herb, wintergreen, cherry, berry, red berry, cranberry, peach, apple, orange, mango, clementine, lemon, lime, tropical fruit, papaya, rhubarb, grape, durian, dragon fruit, cucumber, blueberry, mulberry, citrus fruits, Drambuie, bourbon, scotch, whiskey, gin, tequila, rum, spearmint, peppermint, lavender, aloe vera, cardamom, celery, cascarilla, nutmeg, sandalwood, bergamot, geranium, khat, naswar, betel, shisha, pine, honey essence, rose oil, vanilla, lemon oil, orange oil, orange blossom, cherry blossom, cassia, caraway, cognac, jasmine, ylang-ylang, sage, fennel, wasabi, piment, ginger, coriander, coffee, hemp, a mint oil from any species of the genus Mentha, eucalyptus, star anise, cocoa, lemongrass, rooibos, flax, ginkgo biloba, hazel, hibiscus, laurel, mate, orange skin, rose, tea such as green tea or black tea, thyme, juniper, elderflower, basil, bay leaves, cumin, oregano, paprika, rosemary, saffron, lemon peel, mint, beefsteak plant, curcuma, cilantro, myrtle, cassis, valerian, pimento, mace, damien, marjoram, olive, lemon balm, lemon basil, chive, carvi, verbena, tarragon, limonene, thymol, camphene), flavor enhancers, bitterness receptor site blockers, sensorial receptor site activators or stimulators, sugars and/or sugar substitutes (e.g., sucralose, acesulfame potassium, aspartame, saccharine, cyclamates, lactose, sucrose, glucose, fructose, sorbitol, or mannitol), and other additives such as charcoal, chlorophyll, minerals, botanicals, or breath freshening agents. They may be imitation, synthetic or natural ingredients or blends thereof. They may be in any suitable form, for example, liquid such as an oil, solid such as a powder, or gas.

In some embodiments, the flavor comprises menthol, spearmint and/or peppermint. In some embodiments, the flavor comprises flavor components of cucumber, blueberry, citrus fruits and/or redberry. In some embodiments, the flavor comprises eugenol. In some embodiments, the flavor comprises flavor components extracted from tobacco. In some embodiments, the flavor comprises flavor components extracted from cannabis.

In some embodiments, the flavor may comprise a sensate, which is intended to achieve a somatosensorial sensation which are usually chemically induced and perceived by the stimulation of the fifth cranial nerve (trigeminal nerve), in addition to or in place of aroma or taste nerves, and these may include agents providing heating, cooling, tingling, numbing effect. A suitable heat effect agent may be, but is not limited to, vanillyl ethyl ether and a suitable cooling agent may be, but not limited to eucolyptol, WS-3.

Referring now to FIG. 1, a sheet 1 of aerosol generating material 2 is shown. The aerosol generating material 2 may be any type of aerosol generating material mentioned above. The sheet 1 of aerosol generating material 2 comprises a plurality of elongate partial cuts 3. The plurality of elongate partial cuts 2 extend through at least 55% of a thickness T of the sheet 1 of aerosol generating material 2. The thickness T of the sheet 1 of aerosol generating material 2 may be considered the dimension into the page shown in FIG. 1. The plurality of elongate partial cuts 3 are configured to rupture to form a plurality of elongate strips 4 of aerosol generating material 2 comprising burred edges 5, shown in FIGS. 8 and 9.

By providing a plurality of elongate partial cuts 3 through the thickness T of the sheet 1 of aerosol generating material 2, the sheet 1 of aerosol generating material 2 may be cut so that it is ready to be formed into a rod comprising a plurality of elongate strips 4. The depth of the plurality of elongate partial cuts 3 allows for the uncut portion of the sheet 1 of aerosol generating material 2 to be ruptured to form a plurality of elongate strips 4 when the sheet 1 of aerosol generating material 2 is gathered and curled into a rod in the rod forming process, as will be explained in more detail hereinafter.

In addition, the uncut portion of the sheet 1 of aerosol generating material 2 is advantageous because it holds the partially separated plurality of elongate strips together as they pass through the apparatus. An associated advantage is that the sheet 1 of aerosol generating material 2 is easier to process and less prone to breaking. That is, if a elongate strip 4 were to break, the uncut part of the sheet 1 of aerosol generating material would still result in the downstream portion of that elongate strip 4 being pulled through an apparatus.

In some embodiment, the plurality of elongate cuts 3 may extend through at least 80% of the thickness T of the sheet 1 of aerosol generating material 2. This provides a sheet 1 of aerosol generating material 2 that is easier to rupture into a plurality of elongate strips 4 of aerosol generating material 2 whilst still providing the strength to enable the sheet 1 of aerosol generating material 2 to be pulled through an apparatus without substantial breaking of the sheet 1 of aerosol generating material 2.

The thickness T of the sheet 1 of aerosol generating material 2 may be in the range of about 30 um to 300 um. Preferably, paper sheets will have a thickness in the range of 30 to 200 μm and sheets formed from tobacco, of which various are listed above, preferably have a thickness in the range of 50 to 300 μm, The density of the sheet material may be in the range of about 20 to 250 GSM (grams per square meter). Preferably, the various forms of sheet tobacco will have a density in the range of 50 to 250 GSM, whereas dry gel sheets preferably have a density in the range of 50 to 200 GSM, and paper sheets preferably have a density in the range of 20 to 200 GSM, more preferably between 20 and 100 GSM. Cellophane and natureflex may have properties more closely related to paper sheets, whilst PLA and HDPE may have properties more closely related to dry gel sheets. In the case of laminates, it will be understood that each layer may have a thickness or density in the ranges described above but that the full thickness of the laminate may be outside the range stated above for a single layer material.

As shown in FIG. 1, the plurality of elongate partial cuts 3 may extend in the longitudinal direction L of the sheet 1 of aerosol generating material 2. That is, the plurality of elongate partial cuts 3 may substantially extend in the longitudinal direction L of the sheet 1 of aerosol generating material 2. The plurality of elongate partial cuts 3 may extend substantially parallel to one another. The plurality of elongate partial cuts 3 may extend the entire length of the sheet 1 of aerosol generating material 2. That is, each one of the plurality of elongate partial cuts 3 may be continuous in the longitudinal direction L of the sheet 1 of aerosol generating material 2.

The plurality of elongate partial cuts 3 may be spaced apart in the width direction W of the sheet 1 of aerosol generating material 2. The width direction W is orthogonal with the longitudinal direction L and the thickness T of the sheet 1 of aerosol generating material 2. The plurality of elongate partial cuts 2 may be spaced apart in the width direction W of the sheet 1 of aerosol generating material 2 by a distance in the range of 0.8 mm to 1.2 mm. Preferably, the plurality of elongate partial cuts 3 are spaced apart in the width direction W of the sheet 1 of aerosol generating material 2 by a distance of 1 mm.

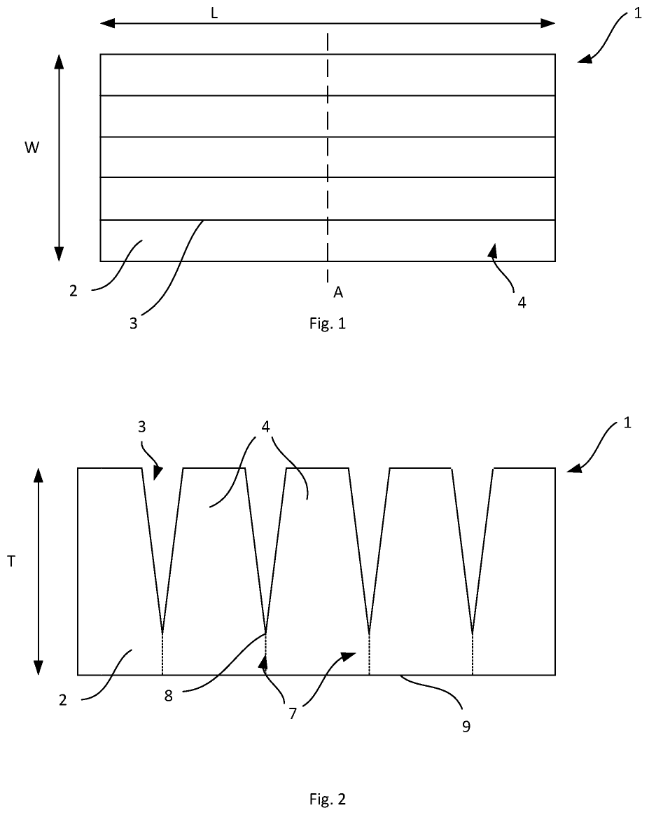

As previously mentioned, the plurality of elongate cuts 3 extend partially through the thickness T of the sheet 1 of aerosol generating material 2 to define a plurality of partially separated elongate strips 4. The plurality of elongate cuts 3 that extend partially through the thickness T of the sheet 1 of aerosol generating material 2 make the sheet 1 easier to gather into a rod. That is, the plurality of elongate cuts 2 make the sheet 1 easier to form into a cylinder shape when gathered. Without wishing to be bound by theory, it is thought that the separation of the material by the cuts partially through the thickness T of the sheet 1 reduces the connected material between the partially separated strips. The reduction in the connections between the partially separated strips allows the strips to compress and bend more easily than a non-cut sheet. Referring to FIG. 2, a cross-sectional view along the plane A of the sheet 1 of aerosol generating material 2 of FIG. 1 is shown. It will be understood that the size of width of the plurality of elongate cuts 3 has been exaggerated for clarity.

It can be seen from FIG. 2 that adjacent partially separated elongate strips 4 are connected by a first connecting portion 7. In some embodiments, the first connecting portion 7 may form the final 45% of the thickness T of the sheet 1 of aerosol generating material 2 that is not separated by the elongate partial cut 3. In some embodiments, the first connecting portion 7 may form the final 20% of the thickness T of the sheet 1 of aerosol generating material 2 that is not separated by the elongate partial cut 3. In some embodiments, the first connecting portions 7 may have a thickness in the range of 5 um to 140 um. The thickness of the first connecting portions 7 may be measured from a base 8 of the elongate partial cut 3 to a bottom surface 9 of the sheet 1 of aerosol generating material 2.

The sheet 1 of aerosol generating material 2 may comprise in the range of 10 to 30 elongate partial cuts 3. When each of the first connecting portions 7 are ruptured, the sheet 1 of aerosol generating material 2 may comprise in the range of 12 to 32 separate elongate strips 4 of aerosol generating material 2 forms from the plurality of elongate partial cuts 3.

Referring now to FIGS. 8 and 9, front and side schematic views of an elongate strip 4 of aerosol generating material 2 are shown, respectively. The elongate strip 4 may be formed when the sheet 1 of aerosol generating material 2 is ruptured. The rupture may take place generally along the dotted lines shown in FIG. 2. The sheet 1 of aerosol generating material 2 may be ruptured when the sheet 1 of aerosol generating material 2 is folded and/or curled during the gathering process, as will be explained in more detail hereinafter.

When one of the elongate partial cuts 2 of the sheet 1 of aerosol generating material 2 is ruptured, a side surface 10 of an elongate strip 4 may comprise a first section 11 and a second section 12. The second section 12 may form the burred edge 5. More specifically, when one of the elongate partial cuts 2 of the sheet 1 of aerosol generating material 2 is ruptured, side surfaces 10 of two adjacent elongate strips 4 may comprise first sections 11 and second sections 12. The second sections 12 may form the burred edges 5.

The second section 12 of the side surface 10 of an elongate strip 4 may have a rougher surface than the first section 11 of the side surface 10 of the elongate strip 4. This is due to the process in which the two sections 11, 12 are formed. The first section 11 of the side surface 10 may be formed by an elongate partial cut 3, performed by a cutting apparatus as will be described in more detail hereinafter, whereas the second section 12 of the side surface 10 maybe formed by a rupture or propagation of a tear.

That is, referring back to FIG. 2, as the sheet 1 of aerosol generating material 2 is gathered, the forces exerted on the first connecting portions 7 cause the first connecting portions 7 of the sheet 1 of aerosol generating material 2 to rupture or a tear to propagate from the base 8 of the elongate partial cut 3 through to the bottom surface 9 of the sheet 1 of aerosol generating material 2, roughly along the dotted line in FIG. 2, and thus separates the partially separated elongate strips 4 of aerosol generating material 2 into separated elongate strips 4 of aerosol generating material 2.

The second section 12 of the side surface 10 may have a greater number of fibers per given length that extend from the side surface 10 of the elongate strip 4 than the first section 11 of the side surface. This is mainly caused by the different separation mechanisms.

That is, the cutting action of a cutting tool may cut upwards of 95% of the fibers of the sheet of aerosol generating material per given length. Thus, up to 5% of the fibers of the sheet of aerosol generating material per given length may be torn in the first section 11. The tearing action may cause some of the fibers to be pulled out of the first section 11 of the side surface.

The tearing action that ruptures the first connecting portions 7 during rod formation causes 100% of the fibers of the sheet 1 in the second section 12 of the side surface 10 to tear. The tearing action may cause some of the fibers to be pulled out of the second section 012 of the side surface. Due to the greater number of tears per given length in the second section 12, when compared to the first section 11, the second section 12 has a rougher and less well defined surface.

Thus, a burred edge 5 could be defined as a surface formed by fibers of the sheet 1 of aerosol generating material 2 where the fibers have been torn to create a rougher surface than the surface formed by a cutting tool.

The burred edges 5 formed by the second section 12 of the side surface 10 of the sheet 1 of aerosol generating material 2 increase the fill value of the aerosol generating material 2, reducing the amount of material required to form a rod, whilst increasing the pressure drop such that the quality of the consumers'experience is not reduced.

The first section 11 may form at least 55% of the length of the side surface 10 in the thickness direction T of the sheet 1 of aerosol generating material 2. The second section 12 may form less than 45% of the length of the side surface 10 in the thickness direction T of the sheet 1 of aerosol generating material 2. In some embodiments, the first section 11 may form at least 80% of the length of the side surface 10 in the thickness direction T of the sheet 1 of aerosol generating material 2. In some embodiments, the second section 12 may form less than 20% of the length of the side surface 10 in the thickness direction T of the sheet 1 of aerosol generating material 2.

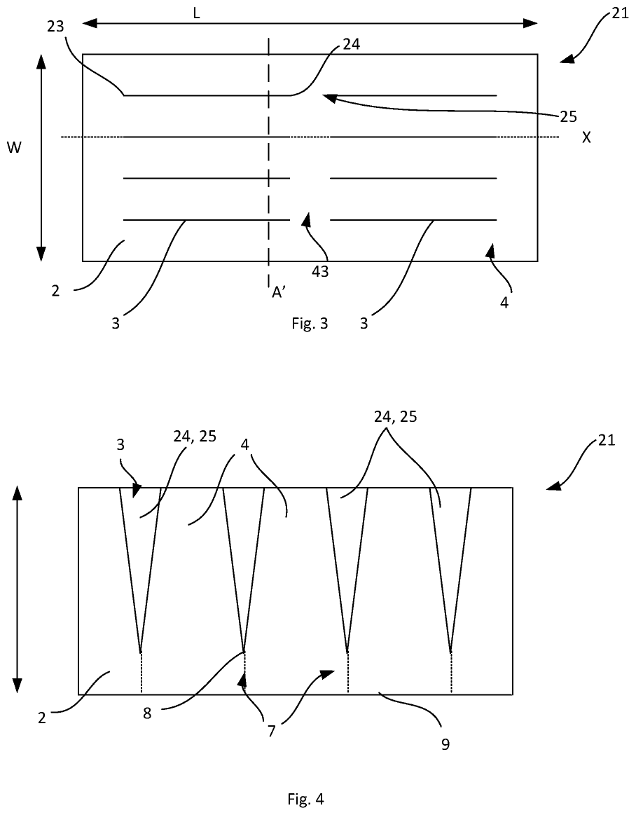

Referring now to FIGS. 3 and 4, a second embodiment of a sheet 21 of aerosol generating material 2 is shown. The embodiment of the sheet 21 of aerosol generating material 2 shown in FIGS. 3 and 4 and is generally the same as the sheet 1 of aerosol generating material 2 shown in FIGS. 1 and 2, so a detailed description thereof will be omitted herein. Furthermore, similar features and components will retain their terminology and reference numerals.

The sheet 21 of aerosol generating material 2 shown in FIGS. 3 and 4 is different to the sheet 1 of aerosol generating material 2 shown in FIGS. 1 and 2 in that at least one of the plurality of elongate partial cuts 3 through the thickness T of the sheet 21 of aerosol generating material 2 extend partially along the longitudinal length L of the sheet 21 of aerosol generating material 2.

In some embodiments, each of the plurality of elongate cuts 3 through the thickness T of the sheet 21 of aerosol generating material 2 extend partially along the longitudinal length L of the sheet 21 of aerosol generating material 2.

In the present embodiment, the sheet 21 of aerosol generating material 2 may comprise a plurality of discrete longitudinally extending elongate partial cuts 3 through the thickness of the sheet 21 of aerosol generating material 2 that are aligned on the same longitudinally extending axis X. That is, a plurality of longitudinally extending elongate partial cuts 3 are discontinuous in the longitudinal direction L of the sheet 1 of aerosol generating material 2. This is in addition to the partial cuts 3 through the thickness of the sheet 21 of aerosol generating material 2, which leave first connecting portions 7 connecting the plurality of partially separated elongate strips 4.

Each of the plurality of discrete elongate partial cuts 3 may comprise a first end 23 and an opposing second end 24. The first end 23 of one of the discrete partial cuts 3 may be the end of the partial cut 3 where the cut was initiated. The second end 24 of one of the discrete partial cuts 3 may be the end of the partial cut 3 where the cut is finished. In FIG. 4, there is shown a cross-sectional view along the plurality of partial cuts 3 at the end of which the first ends 23 of the partial cuts 3 can be seen.

In some embodiments, the plurality of elongate partial cuts 3 may have a length in the longitudinal direction of the sheet in the range of 2 mm to 15 mm. In some embodiments, the plurality of elongate partial cuts 3 may have a length in the longitudinal direction of the sheet in the range of 5 mm to 12 mm The plurality of elongate partial cuts 3 may be defined by second connecting portions 25. That is, a second connecting portion 25 may extend between the second end 24 of one of the discrete partial cuts 3 and the first end of an adjacent discrete partial cut 3 on the same longitudinal axis X. At least one of the second connecting portions 25 may have a thickness equal to the thickness T of the sheet 21 of aerosol generating material 2. Preferably, each of the second connecting portions 25 may have a thickness equal to the thickness T of the sheet 21 of aerosol generating material 2.

In some embodiments, the second connecting portions 25 may have a length in the longitudinal direction L of the sheet 21 of aerosol generating material 2 in the range of 0.1 to 0.4 times the length of one of the plurality of elongate partial cuts 3. Preferably, the second connecting portions 25 may have a length in the longitudinal direction L of the sheet 21 of aerosol generating material 2 of 20% of the length of one of the plurality of elongate cuts 3.

For example, the length of an elongate partial cut 3 in the longitudinal direction of the sheet may be between 1 mm and 40 mm. In some embodiments, the length of an elongate partial cut 3 in the longitudinal direction of the sheet may be between 5 mm and 10 mm. In some embodiments, the second connecting portions 25 may have a length in the longitudinal direction L of the sheet 21 of aerosol generating material 2 in the range of 0.1 mm to 16 mm or in the range of 0.2 mm to 12 mm. In some embodiments, the second connecting portions 25 may have a length in the longitudinal direction L of the sheet 21 of aerosol generating material 2 in the range of 0.5 mm to 4 mm or in the range of 1 mm to 3 mm.

In the present embodiment, the second connecting portions 25 are aligned adjacent to each other across the width of the sheet 21 of aerosol generating material 2. That is, the second connecting portions 25 between adjacent discrete elongate cuts 3 on the same longitudinal axis X are located at the same location in the longitudinal direction as the second connecting portions 25 between adjacent discrete elongate cuts 3 on the same adjacent longitudinal axis X'. Adjacent partial cuts 3 may have their first ends 23 located in the same longitudinal position and may have their second ends 24 located in the same longitudinal position but spaced widthwise from each other. The second connecting portions 25 may be aligned such that a band 26 of aerosol generating material 2 extends transversely across the sheet 21 of aerosol generating material 2, i.e. perpendicularly to the elongate partial cuts 3.

It will be appreciated that the sheet 21 of aerosol generating material 2 may comprise a plurality of second connecting portions 25 in a longitudinal plane that extends orthogonally to a major surface of the sheet 21 of aerosol generating material 2. The major surface of the sheet 21 of aerosol generating material 2 may be, for example, the bottom surface 9.

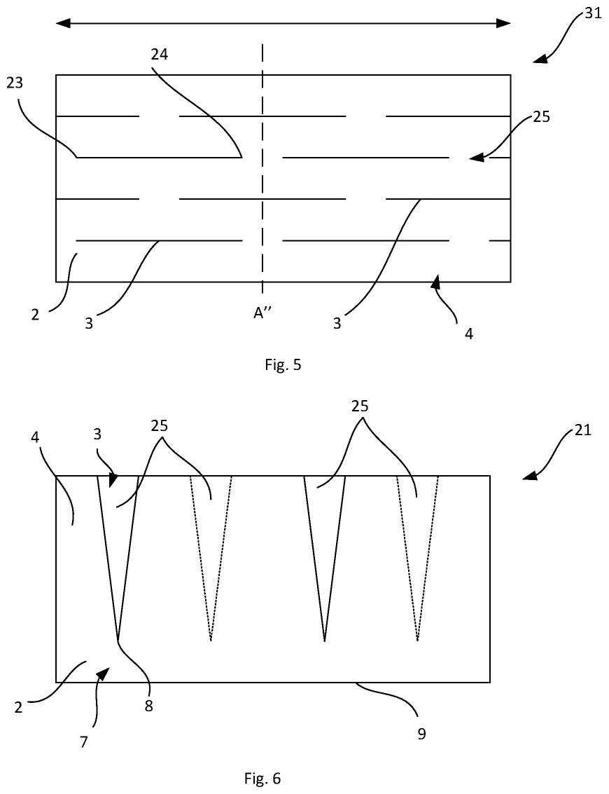

Referring now to FIGS. 5 and 6, a third embodiment of a sheet 31 of aerosol generating material 2 is shown. The embodiment of the sheet 31 of aerosol generating material 2 shown in FIG. 5 and is generally the same as the sheet 21 of aerosol generating material 2 shown in FIGS. 3 and 4, so a detailed description thereof will be omitted herein. Furthermore, similar features and components will retain their terminology and reference numerals.

The sheet 31 of aerosol generating material 2 shown in FIGS. 5 and 6 is different to the sheet 21 of aerosol generating material 2 shown in FIGS. 3 and 4 in that at least one of the second connecting portions 25 is offset in the longitudinal direction L of the sheet 31 of aerosol generating material relative to at least one other of the second connecting portions 25.

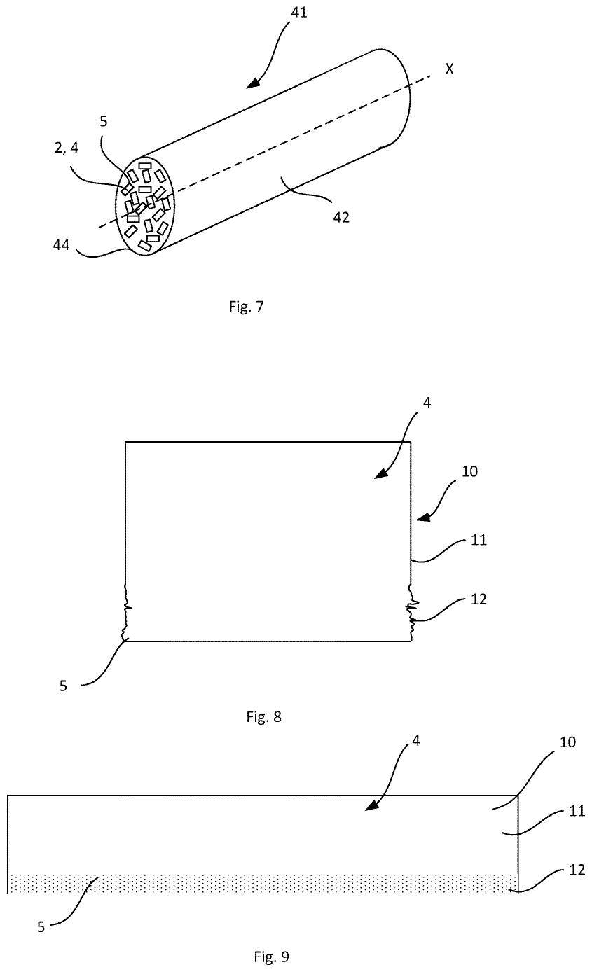

Referring now to FIG. 7, a component 41 for an aerosol generating device is shown. The component 41 comprises a rod 42 of aerosol generating material 2 comprising a plurality of elongate strips 4 of aerosol generating material 2 extending longitudinally through the rod 42. The plurality of elongate strips 4 of aerosol generating material 2 are formed by partially cutting a sheet 1, 21, 31 of aerosol generating material 2 through at least 55% of a thickness T of the sheet 1, 21, 31 of aerosol generating material 2. At least one of the elongate partial cuts 3 is configured to rupture to form a plurality of elongate strips 4 of aerosol generating material 2 comprising at least one burred edge 5.

In some embodiments, the plurality of elongate strips 4 are formed by partially cutting a sheet 1, 21, 31 of aerosol generating material 2 through at least 80% of the thickness T of the sheet 1, 21, 32 of aerosol generating material 2. In some embodiments, each of the elongate partial cuts 3 are configured to rupture to form the plurality of elongate strips 4 of aerosol generating material 2 comprising burred edges 5. Each of the plurality of elongate strips 4 may have a width in the range of 0.8 mm to 1.2 mm. Preferably, each of the elongate strips 4 may have a width of 1 mm.

The burred edge 5 of at least one of the plurality of elongate strips 4 is formed when one of the first connecting portions 7 of the sheet 1, 21, 31 of aerosol generating material 2 is ruptured during gathering of the sheet 1, 21, 32 into a rod 42. When ruptured, a side surface 10 of a elongate strip 4 comprises a first section 11 and a second section 12. The first section 11 of the side surface 10 may be formed by a cutting apparatus. The second section 12 of the side surface 10 may be formed by adjacent partially separate elongate strips 4 being torn apart and the partial cut 3 propagating through the first connecting portion 7. Therefore, the second section 12 of the side surface 10 may have a rougher surface than the first section of the side surface 10. In addition or alternatively, the second section 12 of the side surface 10 may extend out of the plane of the first section 11 of the side surface 10.

In some embodiments, the second section 12 of the side surface 10 may have a length in a direction perpendicular to the longitudinal axis of the component 41 in the range of 5 um to 140 um.

In some embodiments, the plurality of elongate strips 4 of aerosol generating material 2 may be formed by partially cutting the sheet 21, 31 of aerosol generating material in the longitudinal direction, such that the adjacent elongate strips are connected by at least one second connection portion 25 of aerosol generating material 2.

The rod 41 of aerosol generating material 2 may comprise second portions 25 of aerosol generating material 2 that form a band 43 of aerosol generating material 2, shown in FIG. 3. The plurality of elongate strips 4 may extend from the band 43 of aerosol generating material 2. The plurality of elongate strips 4 of aerosol generating material 2 and the band 43 of aerosol generating material may be integrally formed and cut from the same sheet 21, 31 of aerosol generating material 2.

In the present embodiment, the band 43 of aerosol generating material 2 extends transversely to the plurality of elongate strips 4 of aerosol generating material 2, i.e. perpendicularly to the longitudinal axis A of the component 41. The second connecting portions 25 that form the band 43 of aerosol generating material 2 may be located as the same distance in the longitudinal direction from an end 44 of the rod 42 of aerosol generating material 2. That is, the band 43 may extend substantially in a plane comprising a circumference of the rod 42 of aerosol generating material 2.

However, the sheet 21 of aerosol generating material 2 is to be gathered in a manner in which it is folded randomly and so is not likely to be arranged in a circular or spiral pattern within the component 41, although it could be in some embodiments. In an alternative embodiment, the band 43 of aerosol generating material may extend at an acute angle to the longitudinal axis X of the rod 42 of aerosol generating material 2 or in any offset, or alternating, pattern when formed from the sheet 31 of aerosol generating material 2 shown in FIGS. 5 and 6. That is, the second connecting portions 25 of aerosol generating material 2 may be offset in the longitudinal direction of the rod 43 of aerosol generating material 2 to at least one other of the second connecting portions, especially to a second connecting portion 25 between partial longitudinal cuts 3 on a transversely adjacent partial cut 3.

It will be appreciated that the rod 42 of aerosol generating material 2 may comprise a plurality of bands 43 of aerosol generating material 2 that are longitudinally spaced apart within the rod 42 of aerosol generating material 2.

The band 43 of aerosol generating material 2 may have a thickness substantially equal to the thickness of the sheet 21, 31 of aerosol generating material 2. In some embodiments, the second connecting portions 25 or band 43 of aerosol generating material 2 extend longitudinally over 10% to 40% of the length of the rod 42 of aerosol generating material 2. In some embodiments, the second connecting portions 25 or band 43 of aerosol generating material 2 extend longitudinally over about 20% of the length of the rod 42 of aerosol generating material 2.

In some embodiments, the second connecting portions 25 or band 43 of aerosol generating material 2 may have a longitudinal length of 0.1 to 0.4 times the length of an elongate strip 4 of aerosol generating material 2. An elongate strip 4 of aerosol generating material 2 may be considered to be the pitch between the first ends 23 of two adjacent partial cuts 3 in the longitudinal direction. In some embodiments, the second connecting portions 25 or band 43 of aerosol generating material 2 may have a longitudinal length of 0.1 to 0.4 times the length of the partial longitudinal cut through the sheet 21, 31 of aerosol generating material 2.

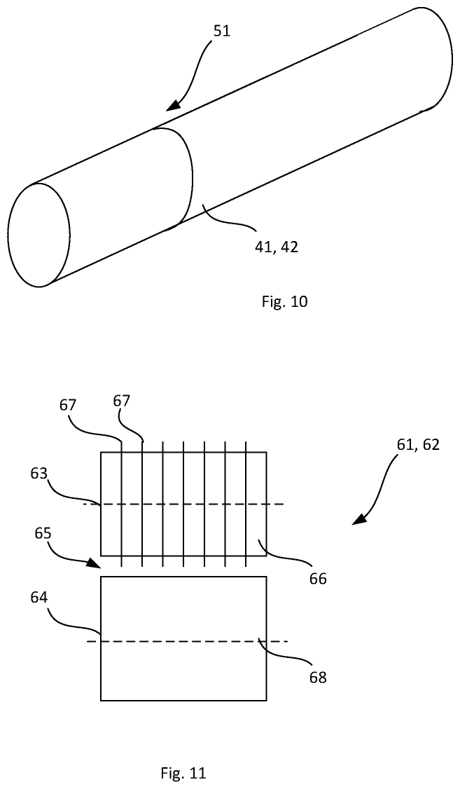

Referring briefly to FIG. 10, there is shown an article 51 comprising the component 41 comprising a rod 42 of aerosol generating material 2 formed from a sheet 1, 21, 31 of aerosol generating material 2, as described above. The article 51 may be an article for an aerosol generating device (not shown).

Referring now to FIG. 11, there is shown a schematic front view of an apparatus 61 for manufacturing a sheet 1, 21, 31 of aerosol generating material 2. The apparatus 61 comprises a first cutter 62. The first cutter 62 is configured to partially cut a sheet 1, 21, 31 of aerosol generating material longitudinally to produce a plurality of elongate partial cuts 3. The first cutter 62 is configured to partially cut through at least 55% of a thickness of the sheet 1, 21, 31 of aerosol generating material 2. In some embodiment, the first cutter 62 may be configured to partially cut through at least 80% of a thickness of the sheet 1, 21, 31 of aerosol generating material 2.

The first cutter 62 may comprises a first portion 63 and a second portion 64. The portion drum 63 and the second portion 64 may be arranged such that there is a gap 65 between their outermost surfaces. That is, the first portion 63 and the second portion 64 maybe arranged such that they are not in contact with one another. The gap between the outermost surfaces of the first and second portions 63, 64 of the first cutter 62 may be between the range of 5 um and 60 um. Therefore, the plurality of partial cuts 3 made into the sheet 1, 21, 31 of aerosol generating material 2 are made without physical contact between the first portion 63 and the second portion 64 of the first cutter 62. This helps to reduce wear on the components of the first cutter 62 and allows for partial cuts 3 to be made into a sheet 1, 21, 31 of aerosol generating material 2.

In some embodiments, the first portion 63 of the first cutter 62 is a cutting drum. The cutting drum 63 may comprises a first drum 66 and a cutting element 67. The first drum 66 may be generally cylindrical and may be configured to rotate about its longitudinal axis. The cutting element 67 extends from the first drum 66 is a direction substantially perpendicular to the longitudinal axis of the first drum 66. The cutting element 67 may be configured to cut longitudinal cuts 3 partially through the thickness of a web of a sheet 1, 21, 31 of aerosol generating material 2.

In the present embodiment, the first portion 63 of the first cutter 62 comprises a plurality of cutting elements 67. The cutting elements 67 are mounted to the first drum 66, which rotates each of the cutting elements 67 at the same angular velocity. The first drum 66 extends transversely to the longitudinal direction of sheet 1, 21, 31 of aerosol generating material 2. That is, the first drum 66 is configured to extend across the width of the sheet 1, 21, 31 of aerosol generating material 2 when the sheet 1, 21, 31 of aerosol generating material 2 is passed through the first cutter 62 to be partially cut in the thickness direction.

In some embodiments, each of the plurality of cutting elements 67 may be separated from an adjacent cutting element 67 by a distance in the range of between 0.5 mm and 2 mm. In some embodiments, each of the plurality of cutting elements 67 may be separated from an adjacent cutting element 67 by a distance in the range of between 0.8 mm and 1.2 mm. In some embodiments, each of the plurality of cutting elements 67 may be separated from an adjacent cutting element 67 by a distance of about 1 mm.

In the present embodiment, the second portion 64 of the first cutter 62 is an anvil drum. The anvil drum 64 comprises a second drum 68. The second drum 68 is generally cylindrical and has a longitudinal axis that extends parallel to the longitudinal axis of the first drum 66. The second drum 68 may comprise a cylindrical outer surface 69. The cylindrical outer surface 69 is configured to contact a sheet 1, 21, 31 of aerosol generating material 2 that passes through the apparatus 61. Due to the gap 65 between the first and second portions 63, 64, the cutting elements 67 of the first portion 63 do not contact the cylindrical outer surface 69 of the second portion 64 of the first cutter 62.

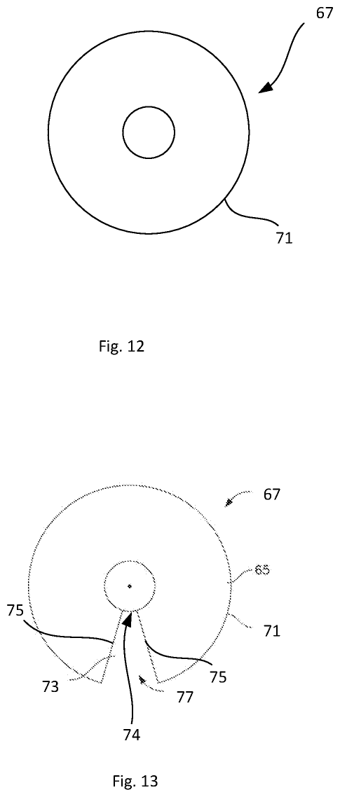

Referring now to FIG. 12, a schematic side view of a cutting element 67 is shown. In the present embodiment, each cutting element 67 comprises a generally annular cutting disk. In some embodiments, each cutting element 67 may be circular or the first portion 63 of the first cutter 62 may comprise a combination of annular and circular cutting elements 67.

Each of the cutting elements 67 may comprise a cutting edge 71. The cutting edge 71 may extend around a periphery of the cutting element 67. Thus, in the present embodiment, the cutting edge 71 is arcuate. The cutting edge 71 may extend circumferentially. That is, the cutting edge 71 of the cutting element 67 is located at its radial extremity and extends circumferentially around the first drum 66. In some embodiments, the cutting edge 71 extends circumferentially about 360 degrees. That is, the cutting edge 71 is continuous. The cutting edge 71 of the cutting element 67 is configured to partially cut through the thickness of a sheet 1, 21, 31 of aerosol generating material 2.

It will be understood that in some embodiments, the cutting element 67 may have an annular, or circular, shape formed by a plurality of arcuate, or sector shaped, segments rather than an integral piece. In such an embodiment, the cutting edges 71 are arcuate and extend circumferentially and combine to form a single continuous cutting edge 71. The cutting edge 71 of the cutting element 67 is configured to partially cut through the thickness of a sheet 1, 21, 31 of aerosol generating material 2.

Referring now to FIG. 13, a schematic side view of a different cutting element 67 is shown. The cutting element 67 shown in FIG. 13 is generally the same as the cutting element shown in FIG. 12 so the terminology and reference numerals of similar feature and components will remain the same. The main difference between the cutting element 67 shown in FIG. 13 and the cutting element 67 shown in FIG. 12 is that the cutting element 67 shown in FIG. 13 does not have a cutting edge 71 that extends circumferentially continuously, as will be explained in more detail hereinafter.

In the present embodiment, the cutting element 67 comprises a notch 73 or cut-out section. The notch 73 may extend in the circumferential direction. In some embodiments, the notch 73 may be formed by completely removing all the material of the cutting element 67 from a sector of the cutting element 67. In some embodiments, the notch 73 may be configured to provide a generally circumferentially extending local area 74 of the at least one cutting element 67 that has a smaller radius than the cutting edge 71.

The notch 73 may extend over a central angle of between 10 to 90 degrees. In some embodiments, the notch 73 may be sector shaped. In some embodiments, the notch 73 may be in the shape of a truncated notch. In such an embodiment, the cutting element 67 may comprise a cutting edge 71 and a local area 74 that extends concentrically with the cutting edge 71 but having a smaller radius, such that it is closer to the longitudinal axis of rotation of the first drum 66 than the cutting edge 71.

In some embodiments, the local area 74 of the notch 73 of the cutting element 67 may have such a small radius that the local area 74 of the notch 73 does not contact the sheet 21, 31 of aerosol generating material 2. In some embodiments, the local area 74 of the notch 73 may contact the sheet 1, 21, 31 of aerosol generating material 2. In such embodiments, the local area 74 of the notch 73 may be configured to discontinue a partial cut 3 being made into the sheet 21, 31 of aerosol generating material 2. The local area 74 of the notch 73 may be connected to the cutting edge 71 by substantially radially extending portions 75.

Therefore, the arcuate cutting edge 71 comprises a gap 77. That is, the arcuate cutting edge 71 is discontinuous. The gap 77 in the arcuate cutting edge 71 is configured not to cut a sheet 21, 31 of aerosol generating material 2 as it passes through the first cutter 61.

In the present embodiment, the notch 73 in the cutting element 67, which causes the gap 77 in the cutting edge 71, is shown as a sector of the cutting element 67 that has been removed. However, it will be appreciated that in alternative embodiments, the notch 73, or cut-out section, may be a different shapes, such as for example, but not limited to, a segment, a triangle, or semi-circle, etc.

In some embodiments, notches 73 on adjacent cutting elements 67 are aligned, as shown in FIG. 14. Therefore, the aligned notches 73 in the cutting elements 67 and the aligned gaps 77 in the cutting edge 71 allow a section of the sheet 21 to remain uncut in the thickness direction, i.e. the second connecting portions 25 described above. The uncut sections, i.e. second connecting portions 25, form a band 43 of aerosol generating material 2 running across the width of the sheet 21 of aerosol generating material 2, perpendicular to the longitudinal direction of the partial cuts 3 through the thickness of the sheet 21 of aerosol generating material 2, as previously described with reference to FIG. 3.

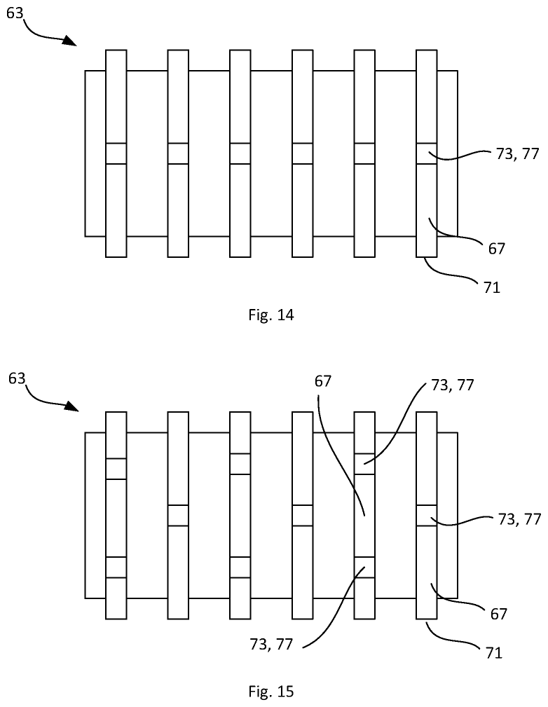

In some embodiments, the notches 73 of adjacent cutting elements 67 may be offset, as shown in FIG. 15. Therefore, the offset notches 73 in the cutting elements 67 and the aligned gaps 77 in the cutting edge 71 allow a section of the sheet 31 to remain uncut in the thickness direction, i.e. the second connecting portions 25. The uncut sections 25 may form a discontinuous or step-wise band 43 of aerosol generating material 2, as previously described with reference to FIG. 5, or may form a band 43 of aerosol generating material 2 that extends at an acute angle to the longitudinal length of the sheet 31 of aerosol generating material 2.

In some embodiments, the notches 73 of adjacent cutting elements 67 may be angularly offset such that the notches 73 partially overlap. In some embodiments, the notches 73 of adjacent cutting elements 67 may be angularly offset such that the notches 73 do not overlap.

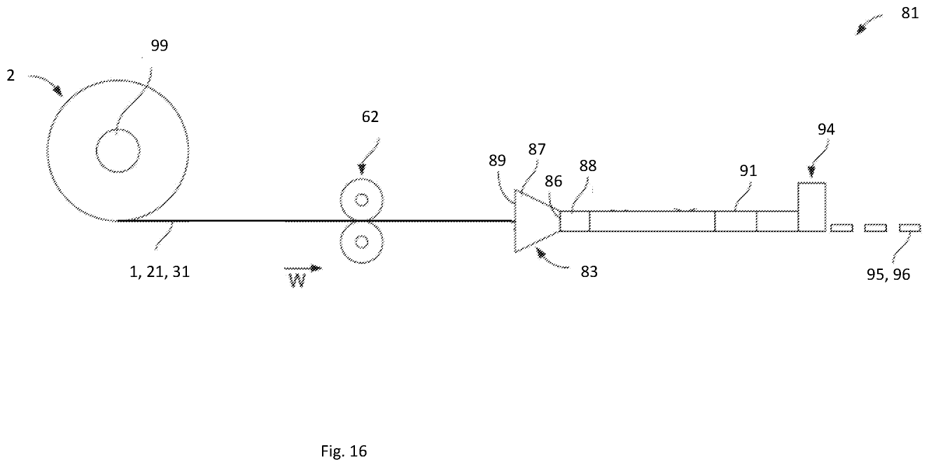

Referring now briefly to FIG. 16, a schematic side view of an apparatus 81 for manufacturing rods of aerosol generating material for an aerosol generating device component is shown. The apparatus 81 comprises the first cutter 62 of the apparatus 61 described above, and so a detailed description thereof will be omitted herein.

The apparatus 81 further comprises a gatherer 83 configured to gather a sheet 1, 21, 31 of aerosol generating material 2, as described above, together to form a rod 84. The rod 84 may be continuous. At least one of the elongate partial cuts 3 formed in the rod 84 by the first cutter 62 rupture to form a plurality of elongate strips 4 of aerosol generating material 2. The plurality of elongate strips 4 extend generally longitudinally through the rod 84.

FIG. 16 shows a schematic side view of the gatherer 83. The gatherer 83 is configured to gather the plurality of partial separated elongate strips 4 of aerosol generating material 2 to form a rod 84 and to rupture the first connecting portions 7 holding adjacent partially separated elongate strips 4 of aerosol generating material 2 during the gathering and rod forming process. In the present embodiment, the gatherer 83 is in the form of a funnel 86. The funnel 86 comprises a funnel portion 87 and a stem portion 88. The funnel portion 87 and the stem portion 88 may be circular is cross section and may be co-axial. The funnel 86 may be symmetrical about its central axis. The funnel portion 87 may narrow from a relatively wide mouth 89 to the relatively narrow stem portion 88.

The partially cut sheet 1, 21, 31 of aerosol generating material travels through the funnel 86 from the funnel portion 87 to the stem portion 88. As the partially cut sheet 1, 21, 31 of aerosol generating material 2 travels through the funnel 91, the narrowing diameter of the funnel portion 87 gathers the partially cut sheet 1, 21, 31 of aerosol generating material 2 together to form a continuous rod 84. As the diameter of the funnel portion 87 narrows, the sheet 1, 21, 31 of aerosol generating material 2 is caused to fold in on itself generally along the partial cuts 3 formed in the sheet 1, 21, 31 of aerosol generating material 2. This folding action can cause the partial cuts 3 to propagate through the first connecting portions 7 of the sheet 1, 21, 31 to produce elongate strips 4 of aerosol generating material 2 with burred edges 5 as a result of the tear.

In some embodiments, the gatherer 83 may be formed by a tray (not shown) having one end narrower than the other end. Therefore, the gatherer 83 may have more of a rectangular or triangular shape than the cone shaped funnel 86 described above.

The apparatus 81 may further comprise a wrapping station 91. The wrapping station 91 may be configured to wrap a continuous sheet of wrapping paper around a circumference of the continuous rod 84 of aerosol generating material 2. The wrapping station 91 may also apply adhesive to the wrapping material to seal the wrapping material in place around the rod 84 of aerosol generating material 2. Thus, once the continuous rod 84 of aerosol generating material 2 has passed through the wrapping station 91, the apparatus has formed a continuous component for an aerosol generating device.

The apparatus 81 further comprises a second cutter 94. The second cutter 94 is configured to cut the rod 84 of aerosol generating material 2 into segments 95 to produce rods 42 of aerosol generating material 2. When the apparatus comprises the wrapping station 91, the second cutter 94 is configured to cut the continuous wrapped rod 84 of aerosol generating material into wrapped segments 96, which form the components 41 described above.

As shown in FIG. 14, the aerosol generating material 2 may be stored as a web of aerosol generating material 2 wound around and stored on a bobbin 99.

Although the method of forming a sheet 1, 21, 31 of aerosol generating material 2 has generally been described above, the method will now be specifically described for completeness. The method comprises cutting a sheet 1, 21, 31 of aerosol generating material 2 longitudinally to produce a plurality of elongate partial cuts 3 in the sheet 1, 21, 31 of aerosol generating material. Cutting the sheet 1, 21, 31 of aerosol generating material 2 comprises partially cutting through at least 55% of a thickness of the sheet 1, 21, 31 of aerosol generating material 2.

In some embodiments, the step of cutting the sheet 1, 21 ,31 of aerosol generating material 2 comprises partially cutting through at least 80% of the thickness of the sheet 1, 21 ,31 of aerosol generating material 2. In some embodiments, the step of cutting the sheet 1, 21 ,31 of aerosol generating material 2 comprises partially cutting through the thickness of the sheet 1 ,21 ,31 of aerosol generating material 2 to define a plurality of partially separated elongate strips 4 connected by a first connecting portion 7 having a thickness in the range of 5 um to 60 um.

In some embodiments, the step of cutting the sheet 1, 21, 31 of aerosol generating material 2 may further comprise partially cutting the sheet 21, 31 of aerosol generating material in the longitudinal direction to form a plurality of elongate partial cuts 3. The step of partially cutting the sheet 21, 31 of aerosol generating material in the longitudinal direction may comprise partially cutting along the length sheet 21, 31 to define a plurality of second connecting portions 25 having a length in the longitudinal direction of the sheet 21, 31 in the range of 0.1 to 0.4 times the length of one of the plurality of elongate partial cuts 3.

In some embodiments, the step of partially cutting along the length sheet 21 to define a plurality of second connecting portions 25 may comprise cutting the sheet 21 of aerosol generating material 2 such that adjacent second connecting portions 25 in the widthwise direction are aligned. In some embodiments, the step of partially cutting along the length sheet 31 to define a plurality of second connecting portions 25 may comprise cutting the sheet 31 of aerosol generating material 2 such that adjacent second connecting portions 25 in the widthwise direction are offset in the longitudinal direction.

Although the method of forming a rod 42 of aerosol generating material 2 has generally been described above, the method will now be specifically described for completeness. The method comprises forming a sheet 1, 21, 31 of aerosol generating material 2, as described above. The method further comprises gathering the sheet 1, 21, 31 of aerosol generating material to form a rod 84 of aerosol generating material and causing the elongate partial cuts 3 to rupture to form a plurality of elongate strips 4 of aerosol generating material 2 that extend substantially longitudinally through the rod 84. The method further comprises cutting the rod 84 of aerosol generating material 2 into segments 95 to produce rods 42 of aerosol generating material 2 for an aerosol generating device component.

The various embodiments described herein are presented only to assist in understanding and teaching the claimed features. These embodiments are provided as a representative sample of embodiments only, and are not exhaustive and/or exclusive. It is to be understood that advantages, embodiments, examples, functions, features, structures, and/or other aspects described herein are not to be considered limitations on the scope of the inventions as defined by the claims or limitations on equivalents to the claims, and that other embodiments may be utilized and modifications may be made without departing from the scope of the claimed invention. Various embodiments of the invention may suitably comprise, consist of, or consist essentially of, appropriate combinations of the disclosed elements, components, features, parts, steps, means, etc, other than those specifically described herein. In addition, this disclosure may include other inventions not presently claimed, but which may be in the future.

1. A sheet of aerosol generating material comprising:
a plurality of elongate partial cuts extending through at least 55% of a thickness of the sheet,
wherein at least some of the elongate partial cuts are configured to rupture to form a plurality of elongate strips of aerosol generating material comprising at least one burred edge.

2. The sheet of aerosol generating material according to claim 1, wherein the plurality of elongate partial cuts extend in the longitudinal direction of the sheet of aerosol generating material.

3. The sheet of aerosol generating material according to claim 1, wherein the plurality of elongate cuts extend through at least 80% of the thickness of the sheet.

4. The sheet of aerosol generating material according to claim 1, wherein the plurality of elongate partial cuts extend through the thickness of the sheet to define a plurality of partially separated elongate strips and wherein adjacent partially separated strips are connected by a first connecting portion.

5. The sheet of aerosol generating material according to claim 4, wherein each of the first connecting portions have a thickness in the range of 5 um and 140 um.

6. The sheet of aerosol generating material according to claim 1, wherein the plurality of elongate partial cuts are spaced apart in the width direction of the sheet by a distance in the range of 0.8 mm to 1.2 mm.

7. The sheet of aerosol generating material according to claim 1, wherein, when one of the elongate partial cuts is ruptured, side surfaces of two adjacent elongate strips comprise a first section and a second section, wherein the second section forms the burred edge and has a rougher surface than the first section.

8. The sheet of aerosol generating material according to claim 7, wherein the second surface is created when adjacent partially separated elongate strips are torn apart and the partial cut propagates through the first connecting portion.

9. The sheet of aerosol generating material according to claim 7, wherein the sheet of aerosol generating material comprises in the range of 10 to 30 elongate partial cuts that, when all ruptured, form in the range of 12 to 32 separated elongate strips.

10. The sheet of aerosol generating material according to claim 2, wherein each of the plurality of elongate partial cuts through the thickness of the sheet extend partially along the longitudinal length of the sheet of aerosol generating material.

11. The sheet of aerosol generating material according to claim 10, wherein the plurality of elongate partial cuts have a length in the longitudinal direction of the sheet in the range of 2 mm to 15 mm.

12. The sheet of aerosol generating material according to claim 10, of wherein the plurality of elongate partial cuts are defined by second connecting portions.

13. The sheet of aerosol generating material according to claim 12, wherein the second connecting portions have a length in the longitudinal direction of the sheet in the range of 0.1 to 0.4 times the length of one of the plurality of elongate partial cuts.

14. A component for an aerosol generating device comprising:
a rod of aerosol generating material comprising a plurality of elongate strips of aerosol generating material extending longitudinally through said rod;
wherein the plurality of elongate strips of aerosol generating material are formed by partially cutting a sheet of aerosol generating material through at least 55% of a thickness of the sheet; and
wherein at least one of the elongate partial cuts is configured to rupture to form a plurality of elongate strips of aerosol generating material comprising at least one burred edge.

15. An article comprising the component for an aerosol generating device according to claim 14.

16. An apparatus for manufacturing a sheet of aerosol generating material, the apparatus comprising:
a first cutter configured to partially cut a sheet of aerosol generating material longitudinally to produce a plurality of elongate partial cuts;
wherein the first cutter is configured to partially cut through at least 55% of a thickness of the sheet of aerosol generating material.

17. The apparatus according to claim 16, wherein the first cutter is configured to partially cut through at least 80% of a thickness of the sheet of aerosol generating material.

18. The apparatus according to claim 16, wherein the first cutter comprises a first portion and a second portion, wherein the first portion and the second portion are arranged such that there is a gap between their outermost surfaces of between the range of 5 um and 140 um.

19. The apparatus according to claim 18, wherein the first portion is a cutting drum comprising a first drum and a plurality of cutting elements, each cutting element having a cutting edge at its radial extremity that extends circumferentially around the first drum.

20. The apparatus according to claim 19, wherein one of the plurality of cutting elements is separated from an adjacent cutting element by a distance in the range of between 0.5 mm and 2 mm.

21. The apparatus according to claim 19, wherein at least one of the cutting elements comprises at least one notch extending in the circumferential direction, the at least one notch being configured to provide a generally circumferentially extending local area of the at least one cutting element that has a smaller radius than the cutting edge.

22. The apparatus according to claim 16, wherein the first cutter is a crush cutting apparatus.

23. A method of forming a sheet of aerosol generating material, the method comprising:
cutting a sheet of aerosol generating material longitudinally to produce a plurality of elongate partial cuts in the sheet;
wherein cutting the sheet of aerosol generating material comprises partially cutting through at least 55% of a thickness of the sheet of aerosol generating material.

24. An apparatus for manufacturing rods of aerosol generating material for an aerosol generating device component, the apparatus comprising:
an apparatus according to claim 16;
a gatherer configured to gather the sheet of aerosol generating material together to form a rod, wherein the elongate partial cuts rupture to form a plurality of elongate strips of aerosol generating material and the plurality of elongate strips extend substantially longitudinally through the rod; and
a second cutter configured to cut the rod into segments to produce rods of aerosol generating material.

25. A method of forming a rod of aerosol generating material for an aerosol generating device component, the method comprising:
forming a sheet of aerosol generating material according to claim 23;
gathering the sheet of aerosol generating material to form a rod of aerosol generating material, wherein the elongate partial cuts rupture to form a plurality of elongate strips of aerosol generating material and the plurality of elongate strips extend substantially longitudinally through the rod; and
cutting the rod of aerosol generating material into segments to produce rods of aerosol generating material for an aerosol generating device component.
